(19) United States
(12) Patent Application Publication
(10) Pub. No.: US 2003/0112224 A1
(43) Pub. Date: Jun. 19, 2003

(54) Apparatus for inputting letters in electronic device and method thereof

(75) Inventors: Young-hwan Pan, Suwon-si (KR); Joon-hwan Kim, Seoul (KR); Mi-ju Park, Seoul (KR)

Correspondence Address: SUGHRUE MION, PLLC, 2100 Pennsylvania Avenue, NW, Washington, DC, 20037-3213, US

(73) Assignee: Samsung Electronics Co., Ltd.

(21) Appl. No.: 10/307,494

(22) Filed: Dec. 2, 2002

(30) Foreign Application Priority Data
Dec. 15, 2001 (KR) 2001-79720

(51) Int. Cl. G09G 5/00

(52) U.S. Cl. 345/171; 345/156

(57) ABSTRACT

An apparatus for inputting letters in an electronic device, which can select and input letters in guide screens showing multiple letter groups linked to each other in a tree structure by using only two direction keys and an enter key, and a method thereof are provided. Accordingly, without installing a keyboard in an electronic device, it is possible to simply input letters on a screen using only two direction keys and an enter key in on-screen display letter input menu screens, by dividing letters into sub groups in a tree structure.

### CROSS-REFERENCE TO RELATED APPLICATIONS

This application is based upon and claims priority from Korean Patent Application No. 01-79720 filed Dec. 15, 2001, the contents of which are incorporated herein by reference.

### BACKGROUND OF THE INVENTION

1. Field of the Invention

The present invention relates to an apparatus for inputting letters in an electronic device and a method thereof, and more particularly, to an apparatus for inputting letters in an electronic device by selecting letters from a guide screen, which shows letter groups linked to one another in a tree structure, using only left and right keys and an enter key and a method thereof.

2. Description of the Related Art

In general, a keyboard is used to display letters on a display screen of an electronic device by inputting the letters into the electronic device. Accordingly, it has been impossible to input letters into an electronic device which does not include a keyboard or cannot be connected to a keyboard.

In particular, in an electronic device like a camcorder, it might be more effective to record images along with text information including the place where the images were taken and the time when the images were taken. However, it has been impossible to input letters into an electronic device not having a complicated letter input device, such as a keyboard.

In order to solve this problem, a technique for inputting letters in an electronic device without a letter input device has been developed. This technology adopts an i-pointer of a remote controller for a digital television (TV) set. Specifically, in a letter input mode, a keyboard screen is displayed on a TV screen. Next, letters are selected by moving the i-pointer on the screen, and then the selected letters are input by hitting an input button.

However, a remote controller including the i-pointer is very expensive. In addition, in the case of an electronic device having a small screen, it is almost impossible to use the i-pointer.

### SUMMARY OF THE INVENTION

To solve the above-described problems, it is an object of the present invention to provide an apparatus for inputting letters into an electronic device using only left and right keys and an enter key on an on-screen-display letter input menu screen showing several letter groups in a tree structure and a method thereof.

Accordingly, to achieve the above object, according to one aspect of the present invention, there is provided an apparatus for inputting letters in an electronic device. The apparatus includes a key input unit which selects a letter input mode and inputs commands necessary to input letters, a memory which divides letter information into multiple groups, stores the information of each of the multiple groups, and stores menu screen information for guiding inputting of letters, according to a tree structure, a controller which controls the memory in response to key commands input from the key input unit, sequentially reads the menu screen information for selecting an uppermost letter group to a lowermost letter group from the memory, reads the information of a letter selected from the lowermost letter group from the memory, and controls the letter information displayed on a letter input window, and a graphic data processor which graphically processes the menu screen information and letter information and performs the processed information to be output as image signals.

In order to achieve the above object, according to another aspect of the present invention, there is provided a method for inputting letters in an electronic device. The method includes (a) dividing letters into multiple groups, storing the information of each of the groups, and storing menu screen information for guiding inputting of letters according to a tree structure, (b) sequentially outputting the menu screen information for selecting an uppermost letter group to a lowermost letter group in response to key commands, and (c) generating image signals corresponding to a letter selected in the menu screen information of the lowermost letter groups.

### BRIEF DESCRIPTION OF THE DRAWINGS

The above object and advantages of the present invention will become more apparent by describing in detail preferred embodiments thereof with reference to the attached drawings in which:

FIG. 1 is a diagram of a signal processor, in which a letter input device according to the present invention is realized;

FIG. 2 is a flowchart of a method for inputting letters into an electronic device according to the present invention;

FIGS. 3A and 3B are diagrams showing a letter input menu screen showing sub-menus in a tree structure according to an embodiment of the present invention;

FIG. 4 is a diagram showing an English letter input menu screen according to an embodiment of the present invention in the case of selecting English in a tree structure showing multiple language choices; and

FIG. 5 is a diagram showing a Japanese letter input menu screen in the case of selecting Japanese in a tree structure showing multiple language choices.

### DETAILED DESCRIPTION OF THE INVENTION

The present invention will now be described more fully with reference to the accompanying drawings, in which preferred embodiments of the invention are shown. The invention may, however, be embodied in many different forms and should not be construed as being defined by the embodiments set forth herein. Rather, these embodiments are provided so that this disclosure will be thorough and complete, and will fully convey the concept of the invention to those skilled in the art. In the drawings, the thickness of layers and regions are exaggerated for clarity. It will also be understood that when a layer is referred to as being “on” another layer or substrate, it can be directly on the other layer or substrate, or intervening layers may also be present. The same reference numerals in different drawings represent the same elements, and thus their description will be omitted.

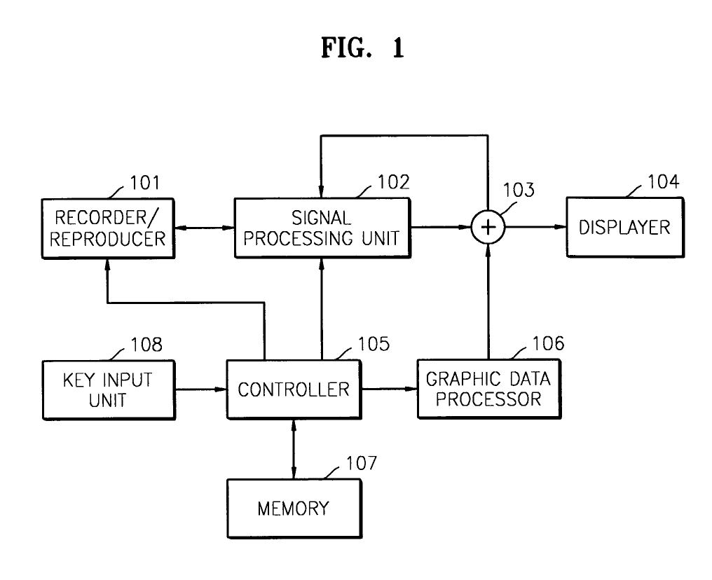

As shown in FIG. 1, a signal processor, which adopts an apparatus for inputting letters into an electronic device according to the present invention, includes a recorder/reproducer 101, a signal processing unit 102, a mixer 103, a displayer 104, a controller 105, a graphic data processor 106, a memory 107, and a key input unit 108.

The recorder/reproducer 101 is a means for recording/reproducing video signals and refers to a device for recording/reproducing signals that is included in an electronic device, such as a camcorder, a television set, or a video cassette recorder (VCR).

The signal processing unit 102 decodes video signals reproduced by the recorder/reproducer 101 and corrects error signals in a reproduction mode. On the other hand, in a recording mode, the signal processing unit 102 encodes input video signals.

After grouping letters, the letter groups are separately stored in the memory 107 in the way that data displayed on menu screens for guiding inputting of letters are linked to one another in a tree structure.

For example, Korean letters may be divided into a consonant group, a vowel group, a number group, and a special character group. Specifically, in the consonant group, consonants may be divided into three groups: a first consonant group ranging from [symbol] to [symbol] , a second consonant group ranging from [symbol] to [symbol] , and a third group ranging from [symbol] to [symbol] . In the vowel group, vowels may be divided into four groups: a first group including [symbol] , [symbol] , [symbol] , and [symbol] , a second group including [symbol] , [symbol] , [symbol] , [symbol] , a third group including ⊥ and [symbol] , and a fourth group including [symbol] and ┐. In the number group, 0 to 4 fall into one group and 5 to 9 fall into another group. Special characters may be divided into multiple groups.

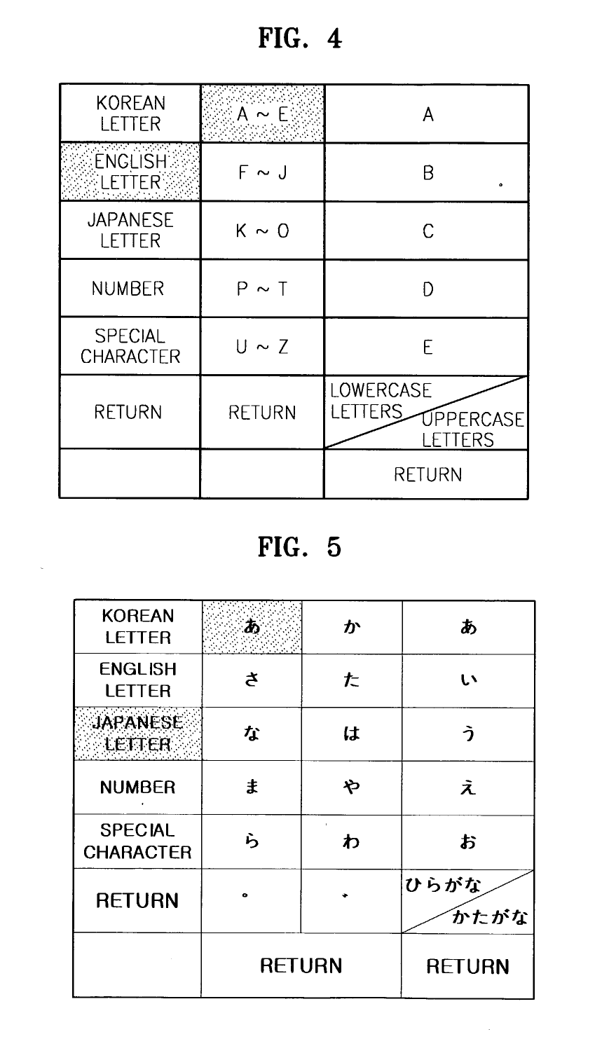

If an apparatus for inputting letters into an electronic device according to the present invention is designed to provide foreign languages, such as English or Japanese, along with Korean, as shown in FIGS. 4 and 5, each language constitutes a group. Then, letters of each language are divided into several sub groups respectively, and the sub groups of each language are stored in the memory 107 respectively. For example, as shown in FIG. 4, English letters may be divided into 5 groups: a first group ranging from A to E, a second group ranging from F to J, a third group ranging from K to O, a fourth group ranging from P to T, and a fifth group ranging from U to Z. Next, lowercase letters in each of the five groups and uppercase letters in each of the five groups are separately stored in the memory.

According to another embodiment of the present invention shown in FIG. 5, Japanese letters are divided into [symbol] , [symbol] , [symbol] , [symbol] , [symbol] , [symbol] , [symbol] , [symbol] , [symbol] , and [symbol] groups.

Menu screens for guiding inputting of letters are linked to one another in a tree structure and are displayed according to an on-screen-display method. In a case where only Korean letters can be input, a menu screen for selecting one of a consonant group, a vowel group, a number group, and a special character group constitutes a main menu screen. When one of these groups is selected on the main menu screen, a sub menu screen showing letter groups of the selected main group is displayed. Sub menu screens are linked to the main screen in a tree structure. When one of the letter groups is selected on the sub menu screen, a lowermost menu screen showing letters in the selected letter group is displayed. Lowermost menu screens are linked to their respective sub menu screens in a tree structure.

As shown in FIG. 4, in a case where an apparatus for inputting letters into an electronic device is designed to be capable of inputting multiple languages, a menu screen for selecting one of a Korean letter group, an English letter group, a Japanese letter group, a number group, and a special character group constitutes a main menu screen, and sub menu screens for displaying letter groups of each of the main groups are linked to the main menu screen in a tree structure. When one of the letter groups is selected on a certain menu screen, a lowermost menu screen for selecting letters in the selected letter group is displayed. Lowermost menu screens are linked to their respective sub menu screens in a tree structure.

The key input unit 108 is for selecting a letter input mode and inputting commands to input letters. The key input unit 108 includes at least two direction keys (up and down keys) and a jog key. Alternatively, the key input unit 108 may be realized into a jog key.

The controller 105 generally controls an electronic device. Specifically, the controller 105 controls the memory 107 in response to the commands input from the key input unit 108 so that menu screen data corresponding to menu selections in a tree structure, consisting of the main menu screen, the sub menu screens, and the lowermost menu screens, can be sequentially read and output from the memory 107 and that letter data selected on the lowermost menu screens can be read from the memory 107.

The graphic data processor 106 converts the menu screen data and the letter data that are read from the memory 107 into image signals through graphic processing and outputs the image signals.

The mixer 103 mixes the video signals processed by the signal processing unit 102 and the graphic image signals processed by the graphic data processor 106 and outputs the mixed signals.

The displayer 104 is a means for displaying signals output from the mixer 103. The displayer 104 may be realized as a monitor, a cathode ray tube, a liquid crystal display, a plasma display, or the like.

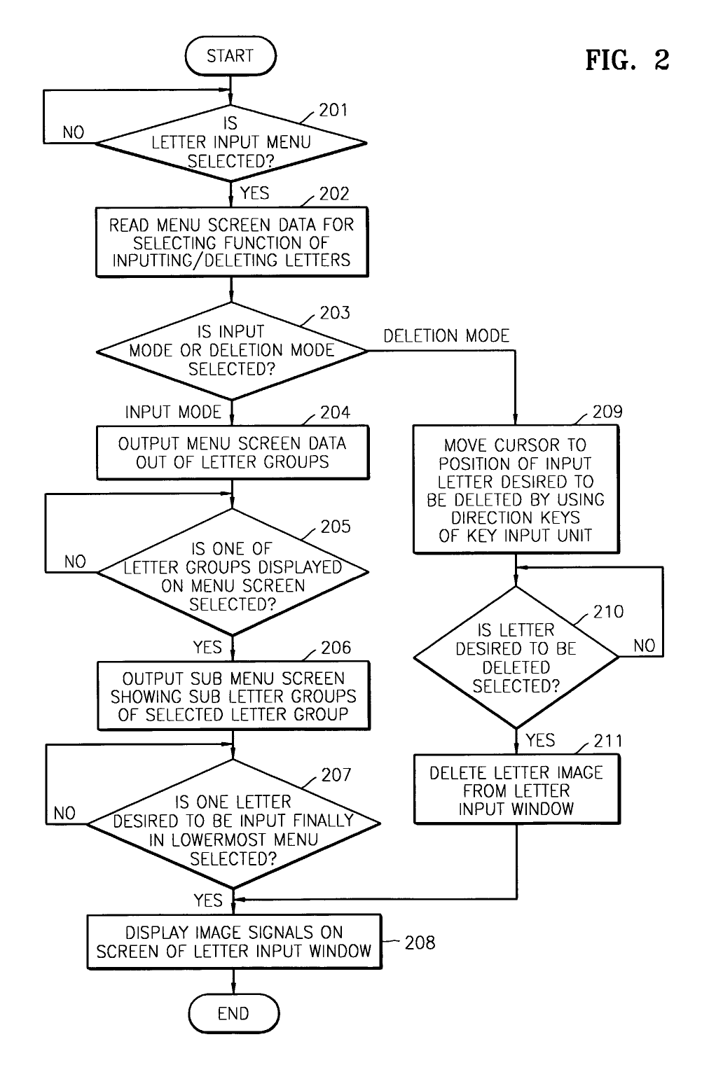

Hereinafter, a method for inputting letters into an electronic device according to the present invention will be described in greater detail with reference to FIGS. 1 and 2.

The controller 105 determines if a letter input menu is selected by the key input unit 108 in step 201. In other words, in the case of a program in which the current mode is switched to a letter input mode when an enter key of the key input unit 108 is input, the controller 105 determines if a letter input menu is selected by the key input unit 108.

In a case where the current mode is switched to a letter input menu in step 201, menu screen data for selecting a function of inputting/deleting letters is read from the memory 107. Next, the menu screen data is converted into image data and is output by the graphic data processor 106 on the screen in step 202.

The controller 105 determines whether an input mode or a deletion mode is selected on the menu screen for selecting a function of inputting/deleting letters in step 203. The input mode is for inputting new letters in a letter input window, and the deletion mode is for deleting input letters.

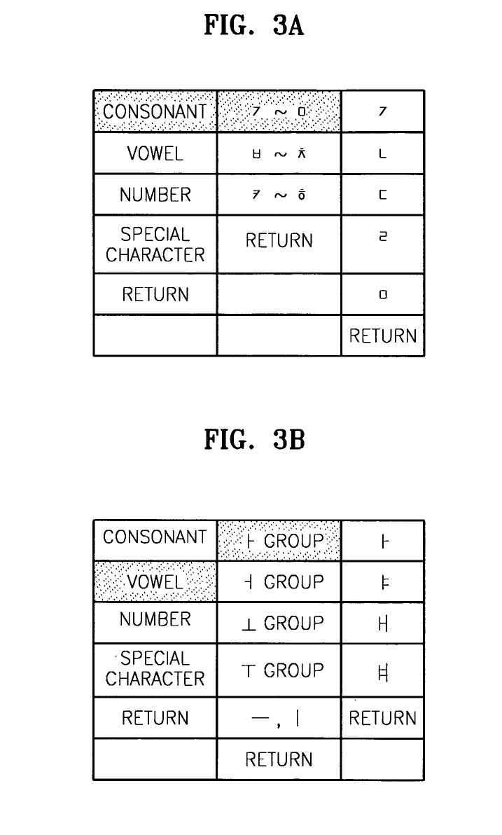

If the input mode is selected in step 203, the apparatus for inputting letters into an electronic device performs in the following way. In a case where the apparatus for inputting letters into an electronic device is designed to be capable of inputting a single language, e.g., Korean as shown in FIG. 3A, menu screen data for selecting one out of letter groups including a consonant group, a vowel group, a number group, and a special character group, is read from the memory 107. Next, the menu screen data is converted into image signals and is output by the graphic data processor 106 in step 204.

On the other hand, if the apparatus for inputting letters into an electronic device is designed to be capable of inputting multiple languages, as shown in FIG. 4, menu screen data for selecting one out of a Korean letter group, an English letter group, a Japanese letter group, a number group, and a special character group is read from the memory 107. Next, the menu screen data is converted into image signals and output by the graphic data processor 106 in step 204.

Next, the controller 105 determines whether one of the letter groups displayed on the menu screen is selected in step 205.

Next, a sub menu screen showing sub letter groups of the selected letter group is output in step 206.

In a case where the apparatus for inputting letters into an electronic device is designed to be capable of inputting a single language, e.g., Korean, menu screens such as those shown in FIGS. 3A and 3B are output.

Specifically, FIG. 3A shows that guide screens for selecting any of letters [symbol] through [symbol] are sequentially output according to a tree structure in which menu screens are linked to their respective upper menus in the case of selecting a consonant group on the uppermost menu screen and selecting a group ranging from [symbol] to [symbol] on the sub menu screen. FIG. 3B shows that guide screens for selecting any of letters [symbol] , [symbol] , [symbol] , and [symbol] in a ‘ [symbol] ’ group are sequentially output according to the tree structure in the case of selecting a vowel group on the uppermost menu screen and selecting the ‘ [symbol] ’ group on the sub menu.

In a case where the apparatus for inputting letters into an electronic device is designed to be capable of inputting multiple languages, menu screens such as those shown in FIGS. 4 and 5 are output.

FIG. 4 shows that guide screens for inputting any of letters A through E are sequentially output according to the tree structure in the case of selecting an ‘English’ menu on the uppermost menu screen and selecting a group ranging from A to E on the sub menu screen showing English letter groups. In order to input lowercase, the apparatus for inputting letters in an electronic device is programmed so that uppercase or lowercase can be converted into lowercase or uppercase, respectively, in a toggle manner by selecting a ‘uppercase’ or ‘lowercase’ item in a menu.

FIG. 5 shows that guide screens for inputting [symbol] , [symbol] , [symbol] , [symbol] , and [symbol] in the lowermost menu screen are sequentially output according to the tree structure in the case of selecting a ‘Japanese’ menu on the uppermost menu screen and selecting the [symbol] group on the sub menu screen showing Japanese letter groups.

For example, in order to input [symbol] [symbol] [symbol] [symbol] , the apparatus for inputting letters is programmed so that hiragana ( [symbol] [symbol] [symbol] [symbol] ) can be converted into katakana ( [symbol] [symbol] [symbol] [symbol] ) or vice versa in a toggle manner when a hiragana/katakana item is selected. In addition, the apparatus for inputting letters is programmed so that a sonant can be input when a sonant item (″) is selected and that a semi-sonant can be input when a semi-sonant item (∘) is selected.

It is determined whether one letter desired to be input is finally selected in the lowermost menu screen in step 207. Next, the information of the selected letter is read out from the memory 107 and is converted into image signals in the graphic data processor 106. Next, the image signals are displayed on a screen of a letter input window in step 208.

If a deletion mode is selected in step 203, the method for inputting letters is performed as follows.

A cursor is moved to the position of an input letter desired to be deleted by using direction keys of the key input unit 108 in step 209.

The controller 105 determines whether a return key is input in a state where in the deletion mode, the cursor is positioned at the letter desired to be deleted in step 210.

If the letter desired to be deleted is selected, the letter image is deleted from the letter input window in step 211.

The menu screens linked to each other in a tree structure include a return item. The apparatus for inputting letters is programmed so that an upper menu screen can be displayed when the return item is selected.

In order to select one of items displayed on each menu screen, a cursor is moved to an item desired to be selected by using two direction keys (up and down keys) installed in the key input unit 108 and the item is selected by inputting an enter key.

According to the apparatus for inputting letters of the present invention, letters are grouped into multiple groups in a tree structure and letters can be input by using two direction keys and an enter key in on-screen display letter input menu screens linked to each other in a tree structure. Accordingly, it is possible to input letters on a screen without the need to install a keyboard in an electronic device.

The present invention may be realized as a method, an apparatus, or a system. In a case where the present invention is realized as software, the elements of the present invention become code segments necessary to perform operations. Programs or code segments can be stored in a processor readable medium or can be transmitted by computer data signals coupled with carrier waves in a transmission medium or a communications network. The processor readable medium includes any medium which can restore or transmit information. For example, the processor readable medium includes an electronic device, a semiconductor memory device, a read only memory (ROM), a flash memory, an erasable ROM (EROM), a floppy disk, an optical disk, a hard disk, an optical fiber medium, or a radio frequency (RF) network. The computer data signals include any signal which can be transmitted through a transmission medium such as an electronic network channel, an optical fiber, atmosphere, an electronic field, or an RF network.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. An apparatus for inputting letters in an electronic device, the apparatus comprising:
a key input unit which selects a letter input mode and inputs commands necessary to input letters;
a memory which divides letter information into multiple groups, stores the information of each of the multiple groups, and stores menu screen information for guiding inputting of letters, according to a tree structure;
a controller which controls the memory in response to key commands input from the key input unit, sequentially reads the menu screen information for selecting an uppermost letter group to a lowermost letter group from the memory, reads the information of a letter selected from the lowermost letter group from the memory, and controls the letter information displayed on a letter input window; and
a graphic data processor which graphically processes the menu screen information and letter information and performs the processed information to be output as image signals.

2. The apparatus of claim 1 further comprising a mixer which mixes video signals processed in the electronic device and the image signals output from the graphic data processor.

3. The apparatus of claim 1, wherein in the case of inputting Korean, the controller divides Korean letters into at least two groups including a consonant group and a vowel group, further divides the consonant group and the vowel group into sub-groups, respectively, and makes it possible to sequentially move from the uppermost letter groups to the lowermost letter groups according to a tree structure.

4. The apparatus of claim 1, wherein the key input unit has only three keys, that is, 2 direction keys and an enter key.

5. The apparatus of claim 1, wherein the menu screen information includes at least menu screen information for selecting a letter input or deletion mode.

6. The apparatus of claim 1, wherein the menu screen information includes menu screen information for selecting any of a consonant group, a vowel group, a number group, and a special character group in the case of inputting Korean letters.

7. The apparatus of claim 6, wherein the menu screen information including the consonant group, the vowel group, the number group, and the special character group is connected to menu screen information for selecting at least one sub group, into which the consonant group, the vowel group, the number group, and the special character group are respectively divided, in a tree structure.

8. The apparatus of claim 1, wherein the menu screen information includes a menu for selecting one of multiple language choices as an uppermost menu, in lower menus connected to the uppermost menu, each of the languages is divided into multiple groups having sub groups, and the multiple groups and their respective sub groups are displayed in a tree structure.

9. The apparatus of claim 1, wherein in a case where an English menu is selected in the menu screen information, the controller displays sub groups, into which English alphabets are divided and controls alphabets included in a selected sub group to be displayed in a tree structure.

10. The apparatus of claim 1, wherein in a case where a Japanese menu is selected in the menu screen information, the controller displays sub groups, into which Japanese letters are divided, and controls letters included in a selected sub group to be displayed in a tree structure.

11. The apparatus of claim 1, wherein the lowermost menu screen information is for finally selecting letters included in a certain sub group of a lowermost level.

12. A method for inputting letters in an electronic device comprising:
(a) dividing letters into multiple groups, storing information of each of the groups, and storing menu screen information for guiding inputting of letters according to a tree structure;
(b) sequentially outputting the menu screen information for selecting an uppermost letter group to a lowermost letter group in response to key commands; and
(c) generating image signals corresponding to a letter selected in the menu screen information of the lowermost letter groups.

13. The method of claim 12, wherein the key commands are generated by only two direction keys and an enter key.

14. The method of claim 12, wherein in step (a), in the case of inputting Korean, Korean letters are divided into at least two groups including a consonant group and a vowel group, the consonant group and the vowel group are further divided into sub-groups, respectively, and it is possible to sequentially move from the uppermost letter groups to the lowermost letter groups according to a tree structure.

15. The method of claim 12, wherein the menu screen information includes at least menu screen information for selecting a letter input or deletion mode.

16. The method of claim 12, wherein the menu screen information includes menu screen information for selecting any of a consonant group, a vowel group, a number group, and a special character group in the case of inputting Korean letters.

17. The method of claim 16, wherein the menu screen information including the consonant group, the vowel group, the number group, and the special character group is connected to menu screen information for selecting at least one sub group, into which the consonant group, the vowel group, the number group, and the special character group are respectively divided, in a tree structure.

18. The method of claim 12, wherein lowermost menu screen information is for finally selecting letters included in a certain sub group of a lowermost level.

19. The method of claim 12, wherein the menu screen information includes a menu for selecting one of multiple language choices as an uppermost menu, in lower menus connected to the uppermost menu, each of the languages is divided into multiple groups having sub groups, and the multiple groups and their respective sub groups are displayed in a tree structure.

20. The method of claim 12, wherein in a case where an English menu is selected in the menu screen information, the controller displays sub groups, into which English alphabets are divided and controls alphabets included in a selected sub group to be displayed in a tree structure.

21. The apparatus of claim 12, wherein in a case where a Japanese menu is selected in the menu screen information, the controller displays sub groups, into which Japanese letters are divided, and controls letters included in a selected sub group to be displayed in a tree structure.
